(19) United States
(12) Patent Application Publication
(10) Pub. No.: US 2026/0227048 A1
(43) Pub. Date: Aug. 6, 2026

(54) LIGHT EMITTING DEVICE PROVIDING IMPROVED VIEWING COMFORT

(71) Applicant: SIGNIFY HOLDING B.V., Eindhoven (NL)

(72) Inventors: SILVIA MARIA BOOIJ, EINDHOVEN (NL); JORIS VREHEN, WAALRE (NL)

(21) Appl. No.: 19/147,738

(22) PCT Filed: Jan. 10, 2024
(86) PCT No.: PCT/EP2024/050508

§ 371 Date: Jul. 14, 2025

(30) Foreign Application Priority Data
Jan. 16, 2023 (EP) 23151709.5

(51) Int. Cl. F21V 3/04; F21K 9/232; F21V 9/40; F21Y 115/10

(52) U.S. Cl. CPC F21V 3/049; F21K 9/232; F21V 9/40; F21Y 2115/10

(57) ABSTRACT

A light emitting device (100) comprises a translucent bulb (101) having a bulb wall (110) that encloses a cavity (120) of the bulb (101). A LED filament (102) is arranged in the cavity (120) of the bulb (101) and connection means (103) are attached to the bulb (101) and configured to connect the LED filament (102) with an electric power supply (150). The bulb wall (110) comprises an outer shell (111), an inner shell (112) and an intermediate structure (113). The intermediate structure (113) is arranged between the outer shell (111) and the inner shell (112) and the intermediate structure (113) is textured on a spatial scale such that a part of the light (160) emitted by the LED filament (102) is reflected as diffuse light (161) towards the cavity (120).

### FIELD OF THE INVENTION

The present invention generally relates to light emitting devices. More specifically, the present invention is related to light emitting devices comprising a translucent bulb enclosing a cavity within which a light emitting diode (LED) filament is arranged.

### BACKGROUND OF THE INVENTION

The original bulb lamps powered by electricity were of the type having metal wire filaments enclosed within more or less evacuated glass bulbs. This type of bulb lamps was the ubiquitous choice of light source for more than a century until the introduction of LEDs. Light sources based on LEDs have now replaced the light bulb as a source of light in homes and in many other locations. Initially, mainly due to the inherent structural characteristics of LEDs, the early LED light sources (i.e. LED lamps) did not resemble the earlier light bulbs and in many cases were considered as aesthetically inferior to a light bulb of the earlier type. Thus, for aesthetic reasons, a desire for light sources having the look of the traditional bulb shaped filament lamp came back when it was found that this was technically feasible to make light sources using LED filaments.

In present day LED filament light sources many small LEDs are mounted closely together on a wire or thin strip, and these LEDs are embedded in phosphor and, when powered, provide an output of light that to a large extent looks similar to the early metal wire filament light bulbs.

However, a drawback with current LED filament lamps is that they can be uncomfortable to look into, because of the high contrast between the brightness of the LED filament and the background.

### SUMMARY OF THE INVENTION

It is of interest to provide a light source that improves the viewing comfort and thereby overcomes drawbacks of current LED filament light sources.

This and other objects are achieved in a first aspect by providing a light emitting device having the features of the appended independent claim. Preferred embodiments are defined in the appended dependent claims.

Hence, according to the present invention, there is provided a light emitting device that comprises a translucent bulb having a bulb wall that encloses a cavity of the bulb. A LED filament is arranged in the cavity of the bulb and connection means are attached to the bulb and configured to connect the LED filament with an electric power supply. The bulb wall comprises an outer shell, an inner shell and an intermediate structure. The intermediate structure is arranged between the outer shell and the inner shell and the intermediate structure is textured on a spatial scale such that a part of the light emitted by the LED filament is reflected as diffuse light towards the cavity.

For example, the intermediate structure may be configured as a texture on the inside of the outer shell. Additionally or alternatively, intermediate structure may be configured as a texture on the outside of the inner shell.

Therewith, the intermediate structure is part of the inner and/or outer shell, because it is applied on the inner side of the outer shell or on the outer side of the inner shell, In a preferred embodiment, the intermediate structure is forming a monolithic part of the inner shell and/or the outer shell.

In other words, a structure inside the translucent bulb wall diffusely reflects part of the light emitted by the LED filament. This has an effect in that the contrast between the direct light from the LED filament and the diffusely reflected light is reduced, as experienced by a viewer looking at the LED filament through the bulb. At the same time, the view of the LED filament itself is not significantly blurred, as experienced by the viewer. Furthermore, no light is lost since the reflected light will undergo further reflections and leave the bulb. Assuming a low absorption, most of the light hence will leave the bulb as useful light. This effect has an advantage in that it improves the viewing comfort for a viewer and thus overcomes the above mentioned drawback with current LED filament lamps.

In some embodiments, the intermediate structure has essentially the same spatial extent as the spatial extent of the outer and inner shells in terms of enclosing the cavity.

Such a configuration provides the improved viewing comfort irrespective of the direction from which the viewer is viewing the LED filament through the bulb.

In some embodiments, the intermediate structure has a spatial extent that is smaller than the spatial extent of the outer and inner shells in terms of enclosing the cavity.

For example, the intermediate structure may be spatially subdivided such that it comprises a plurality of intermediate structure subdivisions. In some embodiments of such a configuration, the intermediate structure subdivisions may comprise at least a first type of texture and a second type of texture.

Such a configuration provides the improved viewing comfort in viewing directions that are determined by the spatial extent of the diffusely reflecting intermediate structure. It is thus possible to, e.g., configure the textured intermediate structure only at one or more desired specific parts of the bulb whereby this specific part or parts provides the diffuse reflection of light only in a desired specific direction or directions.

In some embodiments, the intermediate structure comprises a material that provides the intermediate structure with a spectral selectivity in terms of the wavelength interval of the reflected diffuse light.

For example, in embodiments comprising intermediate structure subdivisions, the intermediate structure subdivisions may comprise at least a first type of material and a second type of material, where the first and second types of material have different spectral selectivity in terms of the wavelength interval of the reflected diffuse light

For example, such a material may comprise any of a plurality of dielectric layers and a semi-transparent metallic layer.

By providing the intermediate structure with such a spectral selectivity with regard to the reflected diffuse light, it is possible to configure the light emitting device with a desired color contrast. That is, light emitted by the LED filament and viewed directly through the bulb will have a first color and the diffusely reflected light will have a second color and thereby providing an increased viewing comfort. The embodiments comprising intermediate structure subdivisions may thus provide an enhanced viewer experience in that the appearance of the light in terms of colour may vary depending on the position of the viewer.

In some embodiments, the intermediate structure comprises a micro-optical structure, and in some embodiments, the intermediate structure comprises a surface roughness.

By selecting a specific type of texture it is possible to determine the characteristics of the reflected diffuse light. For example using a micro-optical structure, the reflected diffuse light can be shaped into a narrow or wide beam of light and also shaped into multiple images of the LED filament.

In some embodiments, the outer and inner shells have one and the same refractive index.

By configuring the light emitting device such that the outer and inner shells have one and the same refractive index, the remaining part of the light emitted by the LED filament, not diffusely reflected by the textured intermediate structure, is transmitted through the shells more or less unaffected in terms of not being blurred. This means that the view of the LED filament inside the bulb, as viewed by the viewer, is unbothered by the inner and outer shells.

The object of providing a light source that improves the viewing comfort and thereby overcomes drawbacks of current LED filament light sources is further achieved, in a further aspect, by a method of manufacturing a light emitting device The method comprises a texturing step, an enclosing step and a connection step. The texturing step comprises providing an inside of an outer shell with an intermediate structure and/or providing an outside of an inner shell with an intermediate structure. The enclosing step comprises joining the inner shell and the outer shell into a bulb wall that encloses a cavity of a translucent bulb. The connection step comprises arranging a LED filament inside the cavity and attaching connection means to the bulb, where the connection means are configured to connect the LED filament with an electric power supply.

In some embodiment, the texturing step further comprises providing the intermediate structure with a material that provides the intermediate structure with a spectral selectivity in terms of the wavelength interval of the reflected diffuse light.

The method of this further aspect provides effects and advantages that correspond to those summarized above in connection with the first aspect.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a side view of a light emitting device,

FIG. 2a and FIG. 2b schematically show a respective micro-optical structure,

FIG. 2c schematically shows a surface roughness structure,

FIG. 3 schematically shows a side view of a light emitting device,

FIG. 4 schematically shows a side view of a light emitting device, and

FIG. 5 is a flow chart of a method of manufacturing a light emitting device.

### DETAILED DESCRIPTION

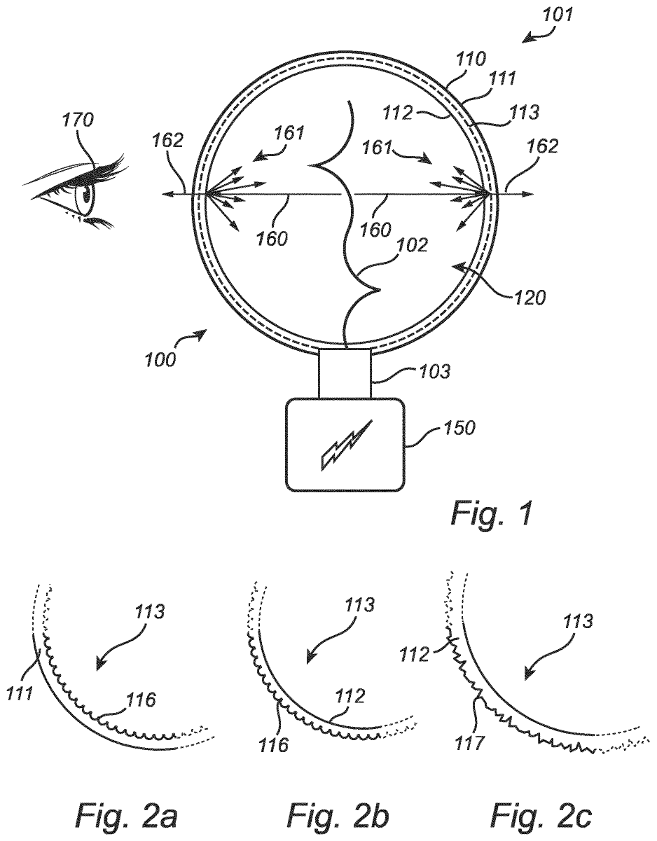

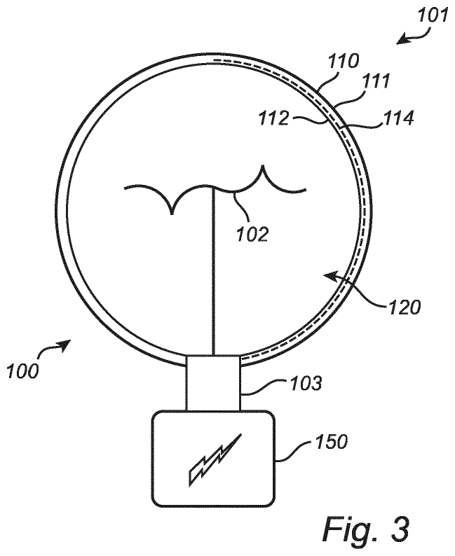

FIG. 1 shows a light emitting device 100 comprising a translucent bulb 101 having a bulb wall 110 that encloses a cavity 120 of the bulb 101. As exemplified in FIG. 1, the bulb 101 is essentially spherical as indicated by the circular outline of the bulb 101. It is to be noted that the specific shape of the bulb 101 is not essential and, to illustrate this fact, another bulb shape will be exemplified below in connection with FIG. 3.

A LED filament 102 is arranged in the cavity 120 of the bulb 101. Although it is not apparent from FIG. 1, the LED filament 102 is in the form of many small LEDs mounted closely together on a wire or thin strip.

Connection means 103 are attached to the bulb 101 and the connection means 103 are configured to connect the LED filament 102 with an electric power supply 150. Details regarding such electrical connection between the LED filament 102 and the power supply 150 are outside the scope of the present disclosure.

The bulb wall 110 comprises an outer shell 111, an inner shell 112 and an intermediate structure 113. The outer shell 111 and the inner shell 112 are made of any suitable material known to the skilled person, for example transparent glass or a polymer. The intermediate structure 113 is arranged between the outer shell 111 and the inner shell 112. The intermediate structure 113 is textured on a spatial scale such that a part of the light 160 emitted by the LED filament 102 is reflected as diffuse light 161 towards the cavity 120.

The way in which the actual arrangement of the intermediate structure 113 is made between the outer and inner shells 111, 112 will be illustrated below in connection with FIGS. 2a-c. In some embodiments, the intermediate structure 113 is configured as a texture on the inside of the outer shell 111 and in some embodiments, the intermediate structure 113 is configured as a texture on the outside of the inner shell 112.

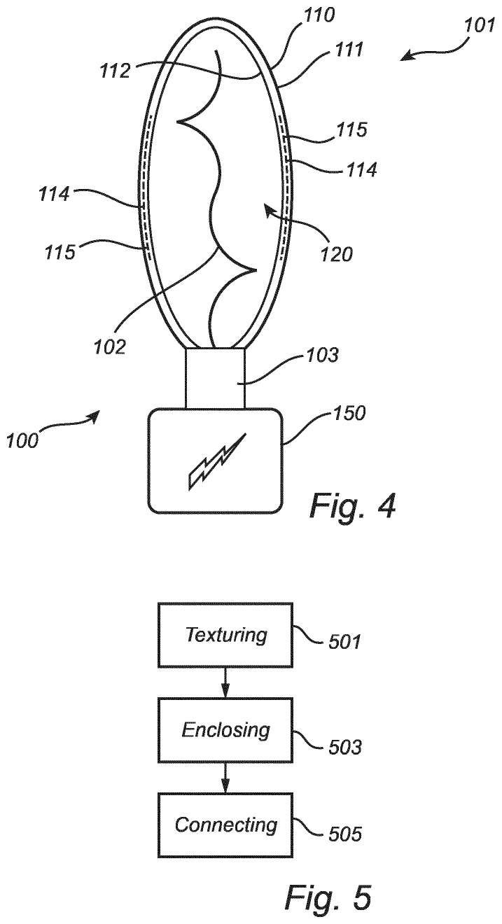

As exemplified by the embodiment in FIG. 1, the intermediate structure 113 has essentially the same spatial extent as the spatial extent of the outer and inner shells 111, 112 in terms of enclosing the cavity 120. Other embodiments will be exemplified below in connection with FIG. 3 and FIG. 4, where the intermediate structure 114 has a spatial extent that is smaller than the spatial extent of the outer and inner shells 111, 112 in terms of enclosing the cavity 120. As will be illustrated below in connection with FIG. 4, the intermediate structure 114 may in some embodiments be spatially subdivided such that it comprises a plurality of intermediate structure subdivisions 115, and these intermediate structure subdivisions 115 may comprise at least a first type of texture and a second type of texture.

In operation, the power supply 150 provides electric power to the LED filament 102, which thereby emits light. The spatial distribution of the light emission is determined by the orientation of the LED filament 102. Most of the light is emitted in directions transverse to the direction in which the LED filament 102 extends and a smaller amount of light is emitted in the longitudinal direction of the LED filament 102. In FIG. 1 this is illustrated by emitted light 160. A viewer 170 views the lighting device 100 from a point outside the bulb 101. The emitted light 160 is partly reflected by the intermediate structure 113 as diffuse light 161, and part of the emitted light 160 reaches the viewer 170 directly through the bulb 101 without being diffusely reflected, as illustrated by direct light 162. It is to be noted that the arrows representing the diffuse light 161 and the arrows representing the direct light 162 are not intended to indicate any relative quantity of light, but only intended to indicate the respective parts of light in a qualitative manner.

From the viewpoint of the viewer 170, the effect is that the direct light 162 passes through the bulb 101 towards the viewer 170, without being affected by interfaces created by the shells 111, 112, 113, resulting in the viewer 170 getting a clear image of the LED filament 102. However, the LED filament 102 will appear less bright to the viewer 170 since a part of the light 160 that reaches the intermediate structure 113 will be scattered in reflection, and diffusely reflect into the cavity 120 and thereby being observable by the viewer 170 in the form of the diffuse light 161. Consequently, the viewer 170 will see both a sharp less bright image of the LED filament 102 and a blurred background glow.

The outer and inner shells 111, 112 may in some embodiments have one and the same refractive index. The direct light 162, resulting from the emitted light 160 transmitted through the shells 111, 112, 113, is then more or less unaffected. This means that the view of the LED filament 102, as viewed by the viewer 170, is not blurred by the inner and outer shells 111, 112.

The intermediate structure 113 may comprise a material that provides the intermediate structure 113 with a spectral selectivity in terms of the wavelength interval of the reflected diffuse light 161. For example, such material may be in the form of a plurality of dielectric layers or a semi-transparent metallic layer. Such a plurality of dielectric layers or semi-transparent metallic layer may during manufacturing be applied, e.g. in the form of a coating, onto either the inside of the outer shell 111 or the outside of the inner shell 112, or applied onto both the inside of the outer shell 111 and the outside of the inner shell 112.

In embodiments where the intermediate structure 114 is spatially subdivided such that it comprises a plurality of intermediate structure subdivisions 115, the intermediate structure subdivisions 115 may comprise at least a first type of material and a second type of material, where the first and second types of material have different spectral selectivity in terms of the wavelength interval of the reflected diffuse light 161.

FIG. 2a illustrates a close-up view of an embodiment of the light emitting device 100 where the intermediate structure 113 comprises a micro-optical structure 116 configured as a texture on the inside of the outer shell 111. Such a micro-optical 116 structure may be in the form of a plurality of micro-lenses as exemplified in FIG. 2a.

FIG. 2b illustrates a close-up view of an embodiment of the light emitting device 100 where the intermediate structure 113 comprises a micro-optical structure 116 configured as a texture on the outside of the inner shell 112. As for the example in FIG. 2a, such a micro-optical 116 structure may be in the form of a plurality of micro-lenses as exemplified in FIG. 2b.

FIG. 2c illustrates a close-up view of an embodiment of the light emitting device 100 where the intermediate structure 113 comprises a surface roughness 117 configured as a texture on the outside of the inner shell 112. Although not illustrated, a similar intermediate structure 113 may be obtained by providing the inside of the outer shell 111 with such a surface roughness 117.

Considering the reflective properties of the semi reflective intermediate structure 113 and by configuring such micro-optical structure 116 or surface roughness 117 in terms of their characterizing parameters, it is possible to configure the intermediate structure 113 with a reflectivity in the interval 10% to 80%. It is thereby possible to configure the lighting device 100 such that a desired level of contrast between the direct light 162 and the diffuse light 161 is obtained and thereby providing a desired viewing comfort for the viewer 170.

FIG. 3 shows a light emitting device 100 similar to the lighting device 100 illustrated in FIG. 1. The lighting device 100 in FIG. 3 comprises a translucent bulb 101 having a bulb wall 110 that encloses a cavity 120 of the bulb 101. Similar to the bulb 101 illustrated in FIG. 1, the bulb 101 is essentially spherical as indicated by the circular outline of the bulb 101. A LED filament 102 is arranged in the cavity 120 of the bulb 101 and connection means 103 are attached to the bulb 101 for connecting the LED filament 102 with an electric power supply 150. The bulb wall 110 comprises an outer shell 111, an inner shell 112 and an intermediate structure 114. The outer shell 111 and the inner shell 112 are made of any suitable material known to the skilled person, for example transparent glass or a polymer.

The intermediate structure 114 is arranged between the outer shell 111 and the inner shell 112 as described and illustrated above. In contrast to the intermediate structure 113 exemplified in FIG. 1, the intermediate structure 114 in FIG. 3 has a spatial extent that is smaller than the spatial extent of the outer and inner shells 111, 112 in terms of enclosing the cavity 120.

In general, this means that the intermediate structure 114 is provided on only a part of on the outer shell 111 and/or inner shell 112. Specifically, in FIG. 3, the intermediate structure 114 is semi-hemispherical and thereby providing the diffuse reflection of light only in a limited angular interval around the bulb 101.

FIG. 4 shows a light emitting device 100 similar to the lighting device 100 illustrated in FIG. 1. The lighting device 100 in FIG. 3 comprises a translucent bulb 101 having a bulb wall 110 that encloses a cavity 120 of the bulb 101. In contrast to the bulb 101 illustrated in FIG. 1, the bulb 101 in FIG. 4 is essentially elliptical. A LED filament 102 is arranged in the cavity 120 of the bulb 101 and connection means 103 are attached to the bulb 101 for connecting the LED filament 102 with an electric power supply 150. The bulb wall 110 comprises an outer shell 111, an inner shell 112 and an intermediate structure 115. The outer shell 111 and the inner shell 112 are made of any suitable material known to the skilled person, for example transparent glass or a polymer. The intermediate structure 114 is arranged between the outer shell 111 and the inner shell 112 as described and illustrated above. In contrast to the intermediate structure 113 exemplified in FIG. 1, the intermediate structure 114 in FIG. 4 has a spatial extent that is smaller than the spatial extent of the outer and inner shells 111, 112 in terms of enclosing the cavity 120. Specifically, in FIG. 4, the intermediate structure 114 is in the form of a plurality of intermediate structure subdivisions 115 and thereby providing the diffuse reflection of light only in limited angular intervals around the bulb 101.

FIG. 5 is a flowchart that illustrates a method of manufacturing the light emitting device 100 described and illustrated above. The method comprises a texturing step 501, an enclosing step 503 and a connection step 505.

The texturing step 501 comprises providing an inside of the outer shell 111 with an intermediate structure. The intermediate structure may be any of the intermediate structures 113, 114, 115 in FIGS. 1, 2a-c, 3. Alternatively or additionally, the texturing step 501 may comprises providing an outside of the inner shell 112 with an intermediate structure 113, 114, 115. In practice, the provision of the intermediate structure 113, 114, 115 may entail etching or moulding the structure into the inside of the outer shell 111 and then applying a liquid, on the textured inside of the outer shell 111, that will harden and thereby forming the inner shell 112. Alternatively or additionally, the provision of the intermediate structure 113, 114, 115 may entail etching or moulding the structure into the outside of the inner shell 112 and then applying a liquid, on the textured outside of the inner shell 112, that will harden and thereby forming the outer shell 111.

The texturing step 503 may in some embodiments further comprise providing the intermediate structure 113, 114, 115 with a material that provides the intermediate structure 113, 114, 115 with a spectral selectivity in terms of the wavelength interval of the reflected diffuse light 161. As exemplified above, such material may be in the form of a plurality of dielectric layers or a semi-transparent metallic layer. Such layer or layers may thus be applied to the inside of the outer shell 111 and/or the outside of the inner shell 112 prior to forming the inner or outer shell, respectively.

The enclosing step 503 comprises joining the inner shell 111 and the outer shell 112 into a bulb wall 110 that encloses the cavity 120 of a translucent bulb 101.

The connection step 505 comprises arranging the LED filament 102 inside the cavity 120 and attaching the connection means 103 to the bulb 101, where the connection means 103 are configured to connect the LED filament 102 with the electric power supply 150.

The person skilled in the art realizes that the present invention by no means is limited to the preferred embodiments described above. On the contrary, many modifications and variations are possible within the scope of the appended claims. For example, the bulb 101 and the LED filament 102 may have different shapes, dimensions and/or sizes than those depicted/described.

1. A light emitting device comprising:
a translucent bulb having a bulb wall that encloses a cavity of the bulb,
a light emitting diode, LED, filament arranged in the cavity of the bulb,
connection means attached to the bulb and configured to connect the LED filament with an electric power supply, wherein:
the bulb wall comprises an outer shell and an inner shell,
wherein at least one of the outer shell and inner shell comprises an intermediate structure being arranged on the inner side of the outer shell and/or on the outer side of the inner shell, and
the intermediate structure is configured as a texture on a spatial scale such that a part of the light emitted by the LED filament is reflected as diffuse light towards the cavity, and wherein the intermediate structure is forming a monolithic part of at least one of the outer shell and the inner shell.

2. (canceled)

3. The light emitting device of claim 1, wherein the intermediate structure has essentially the same spatial extent as the spatial extent of the outer and inner shells in terms of enclosing the cavity.

4. The light emitting device of claim 1, wherein:
the intermediate structure has a spatial extent that is smaller than the spatial extent of the outer and inner shells in terms of enclosing the cavity.

5. The light emitting device of claim 4, wherein:
the intermediate structure is spatially subdivided such that it comprises a plurality of intermediate structure subdivisions.

6. The light emitting device of claim 5, wherein:
the intermediate structure subdivisions comprise at least a first type of texture and a second type of texture.

7. The light emitting device of claim 1, wherein:
the intermediate structure comprises a material that provides the intermediate structure with a spectral selectivity in terms of the wavelength interval of the reflected diffuse light.

8. The light emitting device of claim 7, wherein:
the intermediate structure subdivisions comprise at least a first type of material and a second type of material, where the first and second types of material have different spectral selectivity in terms of the wavelength interval of the reflected diffuse light.

9. The light emitting device of claim 7, wherein the material comprises any of:
a plurality of dielectric layers, and
a semi-transparent metallic layer.

10. The light emitting device of claim 1, wherein:
the intermediate structure comprises a micro-optical structure.

11. The light emitting device of claim 1, wherein:
the intermediate structure comprises a surface roughness.

12. The light emitting device of claim 1, wherein:
the outer and inner shells have one and the same refractive index.

13. A method of manufacturing a light emitting device as claimed in claim 1, comprising a texturing step, an enclosing step and a connection step wherein:
the texturing step comprises providing on an inner side of an outer shell with an intermediate structure and/or providing on an outer side of an inner shell with an intermediate structure, wherein the intermediate structure is configures as a texture on a spatial scale such that a part of the light emitted by the LED filament is reflected as diffuse light towards the cavity, and wherein the intermediate structure is forming a monolithic part of at least one of the outer shell and the inner shell,
the enclosing step comprises joining the inner shell and the outer shell into a bulb wall that encloses a cavity of a translucent bulb, and
the connection step comprises arranging a LED filament inside the cavity and attaching connection means to the bulb, where the connection means configured to connect the LED filament with an electric power supply.

14. The method of claim 13, wherein the texturing step further comprises providing the intermediate structure with a material that provides the intermediate structure with a spectral selectivity in terms of the wavelength interval of the reflected diffuse light.
